(19) United States
(12) Patent Application Publication
(10) Pub. No.: US 2005/0130013 A1
(43) Pub. Date: Jun. 16, 2005

(54) Metal separator for fuel cell and method for producing the same

(75) Inventors: Masao Utsunomiya, Wako-shi (JP); Teruyuki Otani, Wako-shi (JP); Takashi Kuwayama, Wako-shi (JP); Takahiro Takai, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: HONDA MOTOR CO., LTD.

(21) Appl. No.: 11/011,197

(22) Filed: Dec. 15, 2004

(30) Foreign Application Priority Data
Dec. 16, 2003 (JP) 2003-417459
Dec. 16, 2003 (JP) 2003-417483

(51) Int. Cl. H01M 8/02; H01M 2/14

(52) U.S. Cl. 429/34; 429/39; 427/115

(57) ABSTRACT

A metal separator for fuel cells includes: a plate which is corrosion resistant; conductive inclusions projecting at a surface of the plate; a gold covering layer formed above the conductive inclusions; and a compound layer formed between the conductive inclusions and the gold covering layer, the compound layer composed of a component of the conductive inclusions and gold.

### BACKGROUND OF THE INVENTION

1. Field of the Invention

The present invention relates to a metal separator for polymer electrolyte fuel cells and relates to a method for producing the same. In particular, the present invention relates to improved fuel cells, in which an increase in contact resistance of a separator can be avoided by preventing exfoliation of a gold covering layer from a plate, thereby maintaining high power generation efficiency for a long period of time.

2. Description of the Related Art

In polymer electrolyte fuel cells, a separator is applied to each side of a plate-shaped electrode to form a unit having a layered structure, and plural units are stacked to form a fuel cell stack. The electrode is a three-layered structure in which a polymerized electrolytic membrane, which is made of a resin such as an ion-exchange resin, is held by a pair of gas diffusion electrode plates (positive electrode plate and negative electrode plate). In the separator, gas passages, in which gas is circulated between the gas diffusion electrode plate and the separator, are formed. In the fuel cell, an oxidizing gas such as oxygen or air is provided to the gas passages facing the gas diffusion electrode plate at the negative electrode side, and electricity is thereby generated by electrochemical reaction.

A gas-impermeable graphite material or an amorphous carbon material is used as a material for the above separator. The gas impermeable graphite material includes a resin such a phenol resin impregnated in a baked isotropic graphite. The amorphous carbon material is produced by baking a resin such as a phenol resin after forming parts. A graphite-type material formed of a composite material made of a resin and a graphite, or a highly corrosion-resistant metal material such as a stainless steel or a titanium alloy is used as a material for the above separator. A metal-type material having a surface which is plated with a noble metal such as gold or platinum is used as the material for the above separator.

A metal separator for fuel cells was proposed (see Japanese Unexamined Patent Application Publication No. 2000-36309, hereinafter referred to simply as “Document D1”) having separators in which each of the above materials is used, in which the metal separator disclosed in the Document D1 is arranged at both sides of a fuel cell module having a positive electrode, a negative electrode, and an electrolyte disposed therebetween. The metal separator has a groove portion for gas circulation and a noble metal composite plating film, in which a fluororesin or a fluoridated graphite grain is included as a eutectoid material, on at least a surface of the above groove. In addition, for example, a separator for polymer electrolyte fuel cells was proposed (see Japanese Unexamined Patent Application Publication No. 2003-223905, hereinafter referred to simply as “Document D2”), in which the separator has a separator plate and a plastic frame portion. The separator plate has a metal plate having a noble metal film formed on a surface thereof and plural straight gas flow grooves parallel to a surface thereof. The frame portion is heat resistant and acid resistant, and is used for securing a circumferential edge of the separator plate. In the plastic frame portion, a gas flow tube, an induction recess groove, etc., are formed. In the above separators disclosed in the Documents D1 and D2, a surface of a metal plate is covered with gold plating.

However, in the above separators disclosed in the Documents D1 and D2, adhesion of the gold covering layer on the plate is decreased. As a result, contact resistance of the separator is increased, and high power generation efficiency cannot be maintained for a long period of time.

### SUMMARY OF THE INVENTION

The present invention was made in order to solve the above problems in the conventional techniques, and objects of the present invention are to provide a metal separator for fuel cells, which can prevent exfoliation of a gold covering layer from a plate in power generation and can thereby prevent an increase in contact resistance of a separator, and to provide a method for producing the same.

The inventors have intensively researched techniques for preventing exfoliation of a gold covering layer from a plate in power generation. As a result, although a compound layer composed of a component of conductive inclusions and gold was not formed between the conductive inclusions and the gold covering layer in common separators obtained by the conventional techniques disclosed in the Documents D1 and D2, the inventors found that a separator has a region in which the metal element of conductive inclusions (the metal element is Cr in a case in which the conductive inclusion is composed of Cr₂B) and gold are mixed with each other between conductive inclusions and a gold covering layer when the heat treatment is further performed in an inert gas after gold plating. This is because a compound layer in which the composition continuously changes from a component of the conductive inclusion to the gold is generated between the conductive inclusions and the gold covering layer. The inventors found that, in the case in which the above compound layer is formed, adhesion of the conductive inclusions and the gold is improved and exfoliation of the gold covering layer from the plate is prevented. The inventors confirmed that, in a case in which Cr₂B, TiN, ZrN, CrN, TiC, TaC, or CrC, etc., is used as a material of the conductive inclusion, a compound of the above material of the conductive inclusion and the gold is favorably formed by performing heat treating thereon. Whether or not the above compound layer is formed between the conductive inclusion and the gold covering layer can be confirmed by performing an Auger analysis when sputtering the surface in a depth direction thereof so as to perform elemental analysis in the depth direction from the surface.

A metal separator for fuel cells of the present invention was made based on the above findings and includes: a plate which is corrosion resistant; conductive inclusions projecting at a surface of the plate; a gold covering layer formed above the conductive inclusions; and a compound layer formed between the conductive inclusions and the gold covering layer, the compound layer composed of a component of the conductive inclusions and gold.

A method for producing a metal separator for fuel cells includes the steps of: passivation treating a surface of a plate on which conductive inclusions project; forming a gold covering layer by directly plating gold on the conductive inclusions without surface treating after the passivation treating; and forming a compound layer between the conductive inclusions and the gold covering layer by heat treating in an inert gas after forming the gold covering layer, the compound layer composed of a component of the conductive inclusions and gold.

According to the present invention, the compound layer composed of the component of the conductive inclusion and gold is formed between the conductive inclusions and the gold covering layer, so that exfoliation of the gold covering layer from the plate can be prevented during power generation, and an increase in contact resistance of the separator can thereby be prevented. Therefore, the fuel cell having the separator of the present invention can maintain high power generation efficiency over a long period of time.

The inventors confirmed that the above exfoliation is caused by insufficient anchoring effect between the conductive inclusions and the gold covering layer in the common separator obtained by the conventional techniques disclosed in the Documents D1 and D2. The inventors have found that a sufficient anchoring effect can be obtained between conductive inclusions and a gold covering layer when an average roughness Ra of a surface of a plate before gold plating is set at not less than 0.4 μm in order to improve the above anchoring effect. This is because the conductive inclusions and the gold are complicatedly entangled and are closely contacted with each other in the condition in which contact areas of both are sufficiently secured when gold particles are adhered to the roughened surface of the plate. The inventors confirmed that adhesion between the conductive inclusions and the gold covering layer is improved and exfoliation of the gold covering layer from the plate is prevented in the case in which the above good anchoring effect can be obtained. The inventors have found that, when the average roughness Ra exceeds 5.2 μm, projection volume of the conductive inclusions from the plate is large, so that substantial contact areas of the separator and the carbon sheet as the diffusion layer are small and fuel performance is thereby decreased, although adhesion between the conductive inclusions and the gold is improved because of sufficiently securing contact areas thereof. The inventors confirmed that it is desirable to perform etching treating with ferric chloride on a surface of a stainless steel to roughen the plate. The inventors confirmed that desirable sufficient anchoring effect between the conductive inclusions and the gold can be obtained by performing the above etching treating thereon in a case in which Cr₂B, TiN, ZrN, CrN, TiC, TaC, or CrC, etc., is used as a material of the conductive inclusion.

A metal separator for fuel cells of the present invention was made based on the above findings, and includes: a plate which is corrosion resistant; a surface of the plate which have conductive inclusions projecting thereat, the surface of the plate having an average roughness Ra of 0.4 to 5.2 μm; and a gold covering layer formed on the conductive inclusions.

A method for producing a metal separator for fuel cells of the present invention is desirable for producing the above metal separator for fuel cells, and includes the steps of: passivation treating a surface of a plate which have conductive inclusions projecting thereat, the surface of the plate having an average roughness Ra of 0.4 to 5.2 μm; and forming a gold covering layer by directly plating gold on the conductive inclusions without surface treating after the passivation treating.

In the present invention, the average roughness Ra of the surface of the plate before gold plating is set at 0.4 to 5.2 μm, and the reasons for this limitation are as follows. That is, if the above average roughness Ra is less than 0.4 μm, contact areas of the conductive inclusions and the gold cannot be sufficiently secured since projection volume of the conductive inclusions from the plate is small when gold particles are adhered to the surface of the plate, and therefore the conductive inclusions and the gold cannot be complicatedly entangled and cannot be closely contacted with each other. Due to this, a sufficient anchoring effect cannot be obtained and exfoliation of the gold covering layer from the plate cannot thereby be prevented. On the other hand, if the above average roughness Ra exceeds 5.2 μm, contact areas of the conductive inclusions and the gold can be sufficiently secured and the conductive inclusions and the gold can thereby be complicatedly entangled and can be closely contacted with each other. However, since projection volume of the conductive inclusions from the plate is large, substantial contact areas of the separator and the carbon sheet as the diffusion layer is small, so that fuel cell performance is decreased. Therefore, according to the present invention, decrease in fuel cell performance is not caused by designing the average roughness Ra of the surface of the plate before gold plating to be optimum, sufficient anchoring effect can be obtained, exfoliation of the gold covering layer from the plate can thereby be prevented in power generation, and an increase in contact resistance of the separator can be prevented. Therefore, a fuel cell in which the separator of the present invention is used can maintain high power generation efficiency over a long period of time.

### BRIEF DESCRIPTION OF THE DRAWINGS

FIGS. 1A to 1C are diagrams showing a main portion in a production process for a metal separator for fuel cells in a first embodiment according to the present invention, wherein FIG. 1A shows a main portion of the separator before heat treating, FIG. 1B is an enlarged diagram showing a portion of FIG. 1A, and FIG. 1C shows a portion after heat treating corresponding to FIG. 1B.

FIG. 2 is a photograph of a separator produced in each Example of the first and the second embodiments and each Comparative Example of the first and the second embodiments.

FIG. 3 is a graph showing the relationship between Au/(Au+Cr) and Cr/(Au+Cr) and distance from the interface vicinity of a gold covering layer regarding an Example 3 of the first embodiment.

FIG. 4 is a graph showing the relationship between initial contact resistance and contact resistance after energizing and thickness of a Au—Cr compound layer, regarding Comparative Example 1 and Examples 1 to 5 of the first embodiment.

FIGS. 5A to 5C are diagrams showing a main portion of a metal separator for various fuel cells, wherein FIG. 5A shows a case in which an average roughness Ra of a surface of a plate before heat treating is optimum, FIG. 5B shows a case in which the above average roughness Ra is less than 0.4 μm, and FIG. 5C shows a case in which the above average roughness Ra exceeds 5.2 μm.

FIG. 6 is a graph showing the relationship between initial contact resistance and contact resistance after energizing and average roughness of a surface of a plate regarding comparative Examples 2 and 3 and Examples 6 to 10 of the second embodiment.

### DESCRIPTION OF THE PREFERRED EMBODIMENTS

### (1) First Embodiment

A preferable first embodiment of the present invention will be described hereinafter with reference to the Figures.

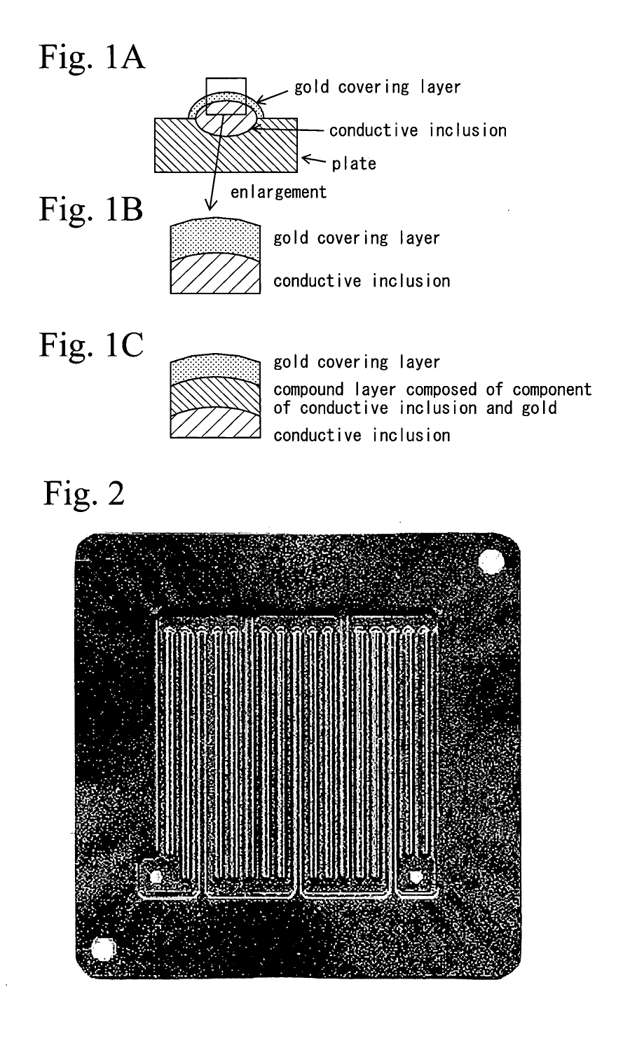

FIGS. 1A to 1C are diagrams showing a main portion in a production process for a metal separator for fuel cells in the first embodiment according to the present invention. In producing a metal separator for fuel cells in the first embodiment according to the present invention, first, a surface of a plate with conductive inclusions projecting therefrom is subjected to a passivation treatment. Next, the conductive inclusions are directly subjected to gold plating without surface treating, so that a gold covering layer is formed on the conductive inclusions. In this state, the gold covering layer made is placed on the conductive inclusions as shown in FIG. 1A. Another layer does not exist between the conductive inclusions and the gold covering layer as shown in FIG. 1B in which a main portion in FIG. 1A is enlarged.

Next, a metal separator is subjected to a heat treatment in an inert gas so that the main portion shown in FIG. 1B is changed as shown in FIG. 1C. That is, in this state, a compound layer composed of a component of the conductive inclusions is formed between the conductive inclusions and the gold covering layer as shown in FIG. 1C. As shown above, by generating the compound layer by the above heat treatment, the compound layer in which components continuously change from the component of the conductive inclusion to the gold is disposed between the conductive inclusions and the gold covering layer. As a result, during electricity generation in a fuel cell, exfoliation of the gold covering layer from the plate can be prevented and an increase in contact resistance in the separator can be prevented.

A Comparative Example 1 and Examples 1 to 5 of the first embodiment according to the present invention will be described hereinafter.

(A) Production of Separator

### COMPARATIVE EXAMPLE 1

A austenite stainless steel plate having components shown in Table 1 was subjected to rolling so as to have a thickness of 0.2 mm, and a thin plate having a square shaped portion of 100 mm×100 mm was obtained by cutting the rolled steel. Next, a plate of a separator shown in FIG. 2 was obtained by press forming the thin plate. This plate had a generation portion having a corrugated cross section at a center portion and a flat edge portion therearound. In the plate, boron is precipitated in a metallographic structure thereof as M₂B type, MB type, and M₂₃ (C, B)₆ type borides. These borides are conductive inclusions forming conductive paths on a surface of a separator.

TABLE 1
(wt %)

| C | Si | Mn | P | S | Cu | Ni | Cr | Mo | Nb | Ti | Al | N | B |
|---|---|---|---|---|---|---|---|---|---|---|---|---|---|
| 0.073 | 0.28 | 0.13 | 0.015 | 0.001 | 0.11 | 10.1 | 20.9 | 2.03 | — | — | 0.08 | 0.03 | 0.60 |

Next, a hard oxide film was formed by performing a passivation treatment on both sides of the plate. The passivation treatment was performed by immersing for 10 minutes in 50 wt % nitric acid bath held at 50° C. after degreasing washing for 10 minutes with acetone. After the passivation treatment, the plate was cleaned for 10 minutes with ordinary temperature water two times and was then dried. Next, both sides of the plate were plated with gold. The gold plating was performed by immersing the plate in a plating bath composed of gold cyanide (3 g/L) for 10 minutes. The gold cyanide was held at 30° C. and current density therein was set at 1 A/dm². After the gold plating, the plate was cleaned for 10 minutes with ordinary temperature water two times, so that a separator of the Comparative Example 1 was obtained.

### EXAMPLES 1 to 5

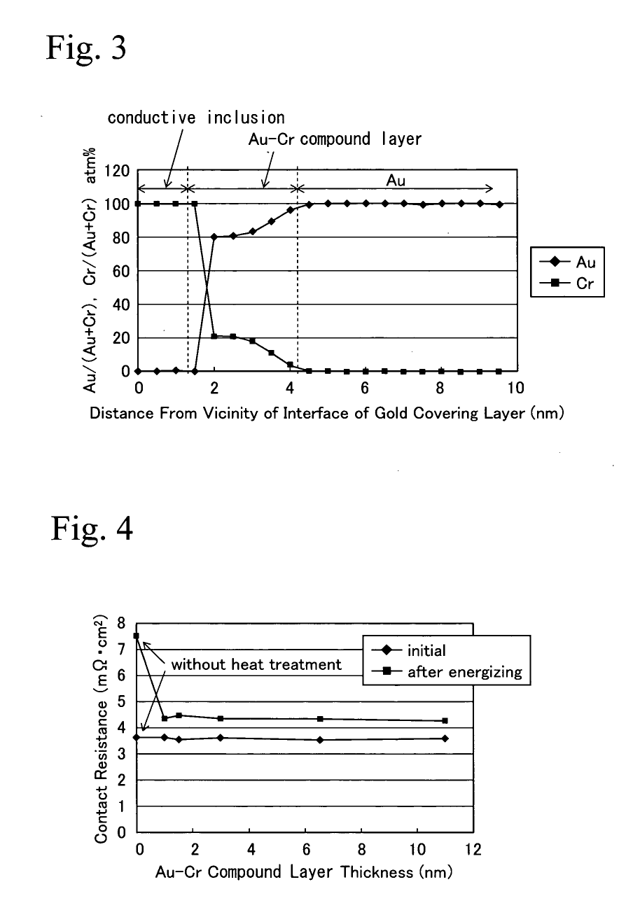

Separators of the Examples 1 to 5 were obtained by subjecting to heat treatment for 3, 5, 10, 20 and 100 minutes in an Ar atmosphere at 300° C. after passivation treating, cleaning, drying, gold plating, and water cleaning used in producing the above separator of the Comparative Example. In the respective Examples 1 to 5, it was confirmed that an Au—Cr compound layer existed between conductive inclusions and a gold covering layer. FIG. 3 is a graph showing the relationship between Au/(Au+Cr) and Cr/(Au+Cr) and distance from the interface vicinity of a gold covering layer, regarding an example of the compound layer (heat treatment time: 10 minutes, Example 3). Table 2 shows the relationship between the above heat treatment time and thickness of the compound layer.

TABLE 2

| | | Thickness of Compound layer |
|---|---|---|
| | Heat Treatment Time (min) | (nm) |
| Example1 | 3 | 1 |
| Example2 | 5 | 1.5 |
| Example3 | 10 | 3 |
| Example4 | 20 | 6.5 |
| Example5 | 100 | 11 |

(B) Measurement of Initial Contact Resistance Regarding the Comparative Example 1 and the Examples 1 to 5.

In the Comparative Example 1 and the Examples 1 to 5, each initial contact resistance was measured at a contact surface pressure of 10 kg/cm² and at a temperature of 25° C.

TABLE 3

| | Thickness of | Initial Contact | Contact Resistance |
|---|---|---|---|
| | Compound layer | Resistance | After Energizing |
| | (nm) | (mΩ · cm²) | (mΩ · cm²) |
| Comparative | 0 | 3.6 | 7.5 |
| Example 2 | | | |
| Example 1 | 1 | 3.6 | 4.3 |
| Example 2 | 1.5 | 3.5 | 4.4 |
| Example 3 | 3 | 3.6 | 4.3 |
| Example 4 | 6.5 | 3.5 | 4.3 |
| Example 5 | 11 | 3.6 | 4.2 |

As shown in Table 3 and FIG. 4, it was confirmed that there is no difference in initial contact resistance value between the separators (the Examples 1 to 5) in which the Au—Cr compound layer was formed by heat treatment and the separator (the Comparative Example 1) in which the compound layer was not confirmed to exist.

(C) Measurement of Contact Resistance After Energizing

Endurance tests in which the separator was left at a temperature of 25° C. for an hour was performed at 250 cycles and for 1250 hours in total after energizing at 75° C. for 4 hours. The measurement of contact resistance was performed at a contact surface pressure of 10 kg/cm² and at a temperature of 25° C. The results are shown in Table 3 and FIG. 4.

As shown in Table 3 and FIG. 4, it is confirmed that contact resistance after endurance test is remarkably increased in the Comparative Example 1 in which heat treatment was not performed (Au—Cr compound layer was not confirmed to exist). On the other hand, it is confirmed that contact resistance is not generally increased in the Examples 1 to 5 in which heat treatment was performed (Au—Cr compound layer has a thickness of not less that 1 nm). This is because adhesion between the conductive inclusions and the gold covering layer is improved and exfoliation of the gold covering layer is prevented since the Au—Cr compound layer is formed between the conductive inclusions and the gold covering layer by heat treating.

In the separator of the present invention, during electricity generation in a fuel cell, exfoliation of a gold covering layer from a plate can be prevented and an increase in contact resistance of the separator can be prevented, so that the separator of the present invention can be used as various power sources in which it is necessary to maintain high generation efficiency, and in particular can be used in many fields such as the automobile industry, the electrical apparatus industry, and the communications industry.

### (2) Second Embodiment

A preffered second embodiment of the present invention will be described hereinafter with reference to the Figures.

In producing a metal separator for fuel cells, first, a surface of a plate composed of stainless steel is subjected to etching treating with ferric chloride, so that average roughness Ra of the surface of the plate is controlled to be 0.4 to 5.2 μm. Next, the surface of the plate at which conductive inclusions projects is subjected to passivation treatment, and the conductive inclusions are directly plated with gold without surface treatment, so that a gold covering layer is formed on the conductive inclusions. In the above manner, although the etching treating is used for surface roughening, the surface roughening method is not limited thereto. For example, blasting can be used for surface roughening.

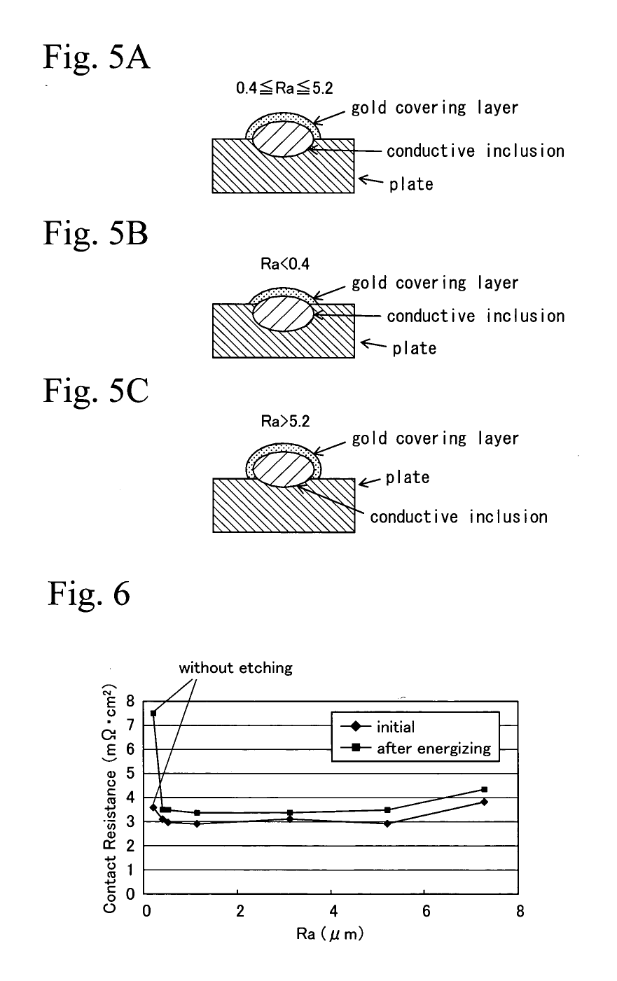

FIGS. 5A to 5C are conceptual main portion diagrams showing states of a metal separator for various fuel cells after gold plating, of which average roughness Ra of the surfaces of the plates are different from each other. As shown in FIG. 5A showing a conceptual main portion of the metal separator for fuel cells, since the average roughness Ra of the surface of the plate before gold plating is 0.4 to 5.2 μm, a projection volume of the conductive inclusion from the plate is within an optimal range. Therefore, better adhesion between conductive inclusions and the gold can be secured because of sufficient contact area therebetween, so that exfoliation of the gold covering layer from the plate can be prevented during electricity generation of the fuel cell.

In contrast, as shown in FIG. 5B showing a conceptual main portion of the metal separator for fuel cells, since the average roughness Ra of the surface of the plate before gold plating is less than 0.4 μm, contact area between the conductive inclusions and the gold cannot be sufficiently secured when gold particles are adhered to the roughened surface of the plate, and the conductive inclusions and gold cannot thereby be complicatedly entangled and cannot be closely contacted. Due to this, sufficient anchoring effect cannot be obtained and exfoliation of the gold covering layer from the plate cannot thereby be prevented. As shown in FIG. 5C showing a conceptual main portion of the metal separator for fuel cells, since the average roughness Ra of the surface of the plate before gold plating exceeds 5.2 μm, projection volume of the conductive inclusion from the plate is large, and substantial contact area between the separator and the carbon sheet as the diffusion layer is small, so that there is the possibility of decrease in fuel performance.

Comparative Examples 2 and 3 and Examples 6 to 10 of the second embodiment according to the present invention will be described hereinafter.

(A) Production of Separator

### COMPARATIVE EXAMPLE 2

A separator of Comparative Example 2 was obtained in the same manner as in the Comparative Example 1. In the separator of the Comparative Example 2, average roughness Ra of a surface of a plate before gold plating was 0.2 μm.

### EXAMPLES 6 TO 10 AND COMPARATIVE EXAMPLE 3

Plates were subjected to etching treating with ferric chloride and controlling the average roughness Ra of the surface of the plate to be 0.4 to 7.3 μm, after passivation treating, cleaning, drying, gold plating, and water cleaning used in producing the above separator of the Comparative Example 2. After that, the plates were plated with gold, and were subjected to water washing, so that separators of the Examples 6 to 10 and Comparative Example 3 were obtained.

(B) Measurement of Initial Contact Resistance Regarding the Comparative Examples 2 and 3 and the Examples 6 to 10

In the Comparative Examples 2 and 3 and the Examples 6 to 10, each initial contact resistance was measured at a contact surface pressure of 10 kg/cm² and at a temperature of 25° C. These results are shown in Table 4 and FIG. 6.

TABLE 4

| | Average Roughness | Initial Contact | Contact Resistance |
|---|---|---|---|
| | of Plate | Resistance | After Energizing |
| | Ra (μm) | (mΩ · cm²) | (mΩ · cm²) |
| Comparative | 0.2 | 3.6 | 7.5 |
| Example 2 | | | |
| Example 1 | 0.4 | 3.1 | 3.5 |
| Example 2 | 0.5 | 3.0 | 3.5 |
| Example 3 | 1.1 | 2.9 | 3.4 |
| Example 4 | 3.1 | 3.1 | 3.4 |
| Example 5 | 5.2 | 2.9 | 3.5 |
| Comparative | 7.3 | 3.8 | 4.3 |
| Example 6 | | | |

As shown in Table 4 and FIG. 6, it is confirmed that the separators subjected to the etching treating before gold plating (Examples 6 to 10) has better contact resistance than the separator plated with gold without the etching treating (Comparative Example 2). This is because the substantial contact area between the separator and the carbon sheet as the diffusion layer is large since the surface of the plate is roughened. In contrast, the separator having average roughness Ra of 7.3 μm (Comparative Example 3) has higher contact resistance than each Example 6 to 10. This is because the substantial contact area between the separator and the carbon sheet as the diffusion layer is small since the projection volume of the conductive inclusions from the plate is large.

(C) Measurement of Contact Resistance After Energizing

Endurance test was performed at 250 cycles and for 1250 hours in total after energizing at 75° C. for 4 hours. In the Endurance test, the separator was left at a temperature of 25° C. for an hour. The measurement of contact resistance was performed at a contact surface pressure of 10 kg/cm² at a temperature of 25° C. The results are shown in Table 4 and FIG. 6.

As shown in Table 4 and FIG. 6, it is confirmed that contact resistance after the endurance test is remarkably increased in the Comparative Example 2 in which the etching treating was not performed. On the other hand, it is confirmed that contact resistance is not generally increased in the Examples 6 to 10 in which the etching treating was performed. This is because the plate is subjected to the etching treating so as to have a roughened surface, so that contact area between conductive inclusions and the gold can be sufficiently secured, the conductive inclusions and gold cannot be complicatedly entangled, and exfoliation of the gold covering layer is prevented.

In the separator of the present invention, during electricity generation in a fuel cell, exfoliation of a covering layer from a plate can be prevented and an increase in contact resistance of the separator can be prevented, so that the separator of the present invention can be used as various power sources in which it is necessary to maintain high generation efficiency, and in particular can be used in many fields such as the automobile industry, the electrical apparatus industry, and the communications industry.

1. A metal separator for fuel cells, comprising:
a plate which is corrosion resistant;
conductive inclusions projecting at a surface of the plate;
a gold covering layer formed above the conductive inclusions; and
a compound layer formed between the conductive inclusions and the gold covering layer, the compound layer composed of a component of the conductive inclusions and gold.

2. The metal separator for fuel cells according to claim 1, wherein the conductive inclusion is selected from the group consisting of Cr₂B, TiN, ZrN, CrN, TiC, TaC, and CrC.

3. A method for producing a metal separator for fuel cells, comprising the steps of:
passivation treating a surface of a plate at which conductive inclusions project;
forming a gold covering layer by directly plating gold on the conductive inclusions without surface treating after the passivation treating; and
forming a compound layer between the conductive inclusions and the gold covering layer by heat treating in an inert gas after forming the gold covering layer, the compound layer composed of a component of the conductive inclusions and gold.

4. The method for producing a metal separator for fuel cells, according to claim 3, wherein the conductive inclusion is selected from the group consisting of Cr₂B, TiN, ZrN, CrN, TiC, TaC, and CrC.

5. A metal separator for fuel cells, comprising:
a plate which is corrosion resistant;
a surface of the plate which have conductive inclusions projecting thereat, the surface of the plate having an average roughness Ra of 0.4 to 5.2 μm; and
a gold covering layer formed on the conductive inclusions.

6. The metal separator for fuel cells according to claim 5, wherein the conductive inclusion is selected from the group consisting of Cr₂B, TiN, ZrN, CrN, TiC, TaC, and CrC.

7. A method for producing a metal separator for fuel cells, comprising the steps of:
passivation treating a surface of a plate which have conductive inclusions projecting thereat, the surface of the plate having an average roughness Ra of 0.4 to 5.2 μm; and
forming a gold covering layer by directly plating gold on the conductive inclusions without surface treating after the passivation treating.

8. The method for producing a metal separator for fuel cells according to claim 7, the method further comprising a step of:
roughening a surface of the plate by etching treating with ferric chloride before the passivation treating, so that the surface of the plate has an average roughness Ra of 0.4 to 5.2 μm.

9. The method for producing a metal separator for fuel cells according to claim 7, wherein the conductive inclusion is selected from a group consisting of Cr₂B, TiN, ZrN, CrN, TiC, TaC, and CrC.
